(19) United States
(12) Patent Application Publication
(10) Pub. No.: US 2007/0266751 A1
(43) Pub. Date: Nov. 22, 2007

(54) Biosolid waste transformation process

(75) Inventors: George Black, Siloam Springs, AR (US); Robert Bayliss, Scarsdale, NY (US)

Correspondence Address: MIRICK, O'CONNELL, DEMALLIE & LOUGEE, LLP, 1700 WEST PARK DRIVE, WESTBOROUGH, MA, 01581, US

(73) Assignee: BlackStone Business Group, Inc., Plymouth, MA (US)

(21) Appl. No.: 11/434,994

(22) Filed: May 16, 2006

(51) Int. Cl. C05D 9/02

(52) U.S. Cl. 71/11

(57) ABSTRACT

A process for transforming beneficial organic nutrient-rich products from raw organic biosolid waste material is provided. The process includes mixing the raw organic biosolid waste material with an oxidizing agent and maintaining a relatively high level of moisture content by weight during the mixing. One or more other additives including, for example, an enzyme, may be included in the mixture. The mixture is dried and pelletized to a particle size in a selectable range. Further additives may be included with the dried and pelletized organic biosolid product to create a beneficial nutrient-rich product for plants and animals with minimal adverse environmental effect. The mixing may occur in a batch-wise or continuous manner. Moisture and/or nutrient sensors may be used to observe the transformation and the resulting information may be feedback into a controller to adjust water and/or additive introduction.

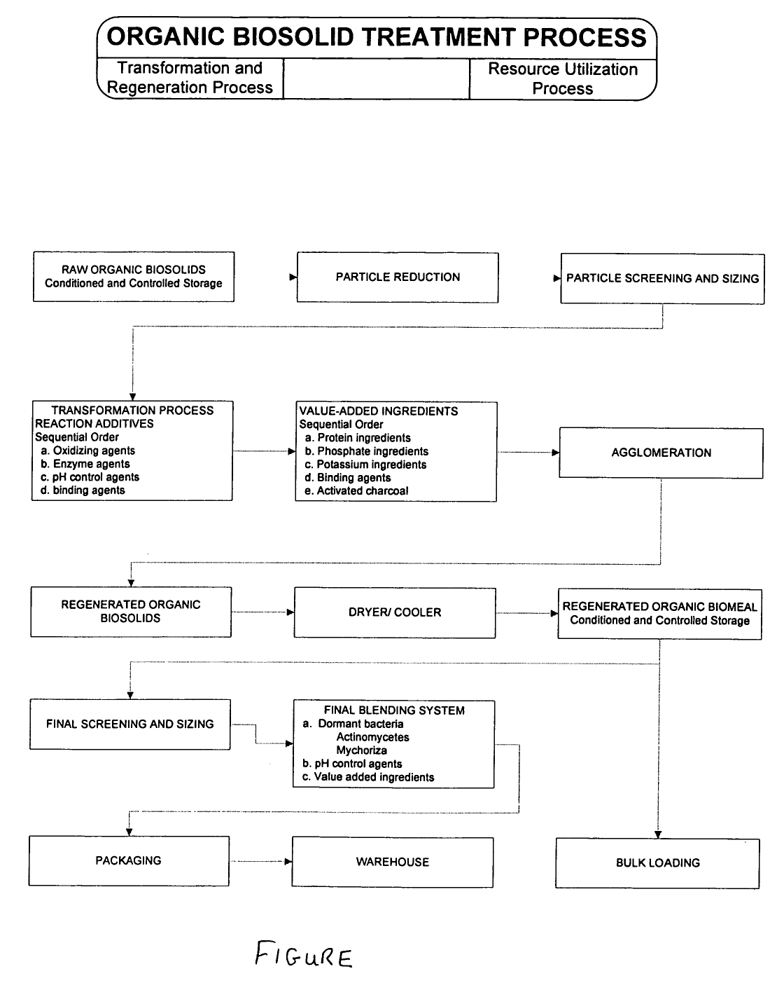

### TECHNICAL FIELD

The present invention relates generally to a process for transforming biosolid waste material into useable organic products. More particularly, the present invention relates to the addition of one or more chemicals to the biosolid waste material and the performance of one or more mechanical steps to convert the biosolid waste material into one or more organic products dependent upon the additives and steps employed.

### BACKGROUND OF THE INVENTION

As a result of expansion and industrialization of concentrated animal feeding operations, great concern has been directed toward a resulting quantitative increase in animal biosolid waste, especially poultry litter and hog manure. Both poultry litter and hog manure emit malodors and are known to cause severe environmental pollution.

Attempts have been made in the past to treat and deodorize these animal manures and other sources of organic biosolid waste materials as described in Ueotani et al, U.S. Pat. No. 5,411,567. The Ueotani et al patent describes fermentation products which are composed essentially of poultry litter components. The fermentation products are derived from reacting poultry litter materials with concentrated sulfuric acid and calcium silicate. The fermentation products result from the reaction mixture by the use of a selected class of bacteria. Unfortunately, however, using sulfuric acid in the reaction causes other potential health and environmental problems which should be avoided in a commercial fermentation product.

Additionally, in the past, other attempts have been made to treat organic biosolid waste materials. U.S. Pat. No. 4,050,917 to Varro describes a composting process which is an extremely long and highly odorous process. The end result of the Varro process has not proven to be a highly acceptable environmental product for use in agricultural and urban communities due to the mentioned notably high odor content and remarkable lack of nutrient supply. U.S. Pat. No. 4,177,575 to Brooks describes a drying and pelletizing process for raw organic waste materials, such as hog manure and poultry litter animal biosolids waste material. The Brooks patent merely describes a composting and drying processes which does not produce a final product that is fully accepted by urban and agricultural communities due, once again, to extreme odor and minimal nutrient supply. U.S. Pat. No. 5,730,772 to Staples describes a drying process for turning poultry litter into fertilizers. Once again, the odors associated with a drying process such as described in the Staples patent are unacceptable in urban and agricultural communities. U.S. Pat. No. 5,876,479 to Hedgpeth describes a composition and method of manufacturing a liquid humic acid based soil enhancer and not a fertilizer or nutrient source for animals and plants.

Unfortunately, the patented processes described above are limited to one or more of: composting, digesting, fermenting and/or drying (only), which have produced products with only limited nutrient value. Such products will only continue to contribute to soil, water, and air pollution and environmental concerns. Accordingly, there exists a need for a process that treats biosolid waste material to produce highly beneficial and environmentally safe products. Additionally, a need exists for a developed biosolid waste treatment process which integrates biological, chemical, and physical treatment agents under controlled conditions, with timely scheduled treatment processes, thereby creating an organic biomeal, substantially odorless, environmentally safe, nutrient-rich product for plants and/or animals.

### SUMMARY OF THE INVENTION

It is an object of the present invention to provide a process for treating biosolid waste material to produce highly beneficial and environmentally safe products. It is also an object to provide a biosolid waste treatment process which integrates biological, chemical, and physical treatment agents under controlled conditions, with timely scheduled treatment processes to create at least an organic biomeal, substantially odorless, environmentally safe, nutrient-rich product for plants and/or animals.

These and other objects are achieved with the present invention, which is a resource regeneration process for creating an organic biomeal nutrient-rich product from raw biosolid waste material. The process includes one or more of the steps of: 1) mixing and conditioning the raw organic biosolid waste material to a substantially uniform size; 2) oxidizing the raw organic biosolid waste material; 3) secondarily mixing the oxidized and transformed organic biosolid waste material; and 4) drying the oxidized and regenerated organic biosolid waste material. These steps complete the resource regeneration process for creating an organic biomeal nutrient-rich product from raw biosolid waste material. The resource regeneration process may be completed within a well defined period of time such as, for example, within a time range of approximately between about ten (10) minutes and about sixty (60) minutes.

More specifically, additional features of the resource regeneration process include the optional step of removing trash from litter via multi-stage screening. It may also include the optional step of reducing particle size through a hammermill or other type of crushing device. While the process will generally be described herein as a batch process, it may alternatively be performed as a continuous process. For that optional way of performing the steps of the process, long mixing augers may be rotated at the correct rotational rate (revolutions per minute) selectable for the particular materials joined together to provide the necessary contact time.

The process of the present invention further includes the step of adding one or more selectable chemicals to aid in the modification of the original biosolid waste material into useable products. The addition of multiple chemicals may occur in one step or in sequential steps. Chemicals generally determined to be suitable for the transformation and regeneration of the biosolid material and chicken litter in particular, include, but are not limited to: 1) an oxidizer such as peroxide; 2) an enzyme such as progest; 3) an acid such as ph304-29; 4) feathermeal or other natural protein; 5) Yucca extract or molasses; 6) one or more potassium-enhancing compounds; 7) one or more phosphate-enhancing compounds; and/or 8) activated charcoal. The addition of one or more of these particular additives may occur prior to agglomeration (or pelletizing) and/or drying. Further additives that may be selectably applied to the mixture include one or more inoculants comprising dormant bacteria, such as actinomycetes and/or mychoriza. The inoculants are preferably added during the process before bagging as described herein.

The process of the present invention further includes the optional step of using one or more measuring and/or control instruments, such as infrared measuring instruments, to detect and control moisture and nitrogen concentrations of the mixture during the process. The control arrangement may be coupled to water pumps and/or additive feeders with automated feedback loops to ensure that additions are timely made and in suitable quantities to produce desired products. Sensors may also be deployed in the system to measure pH level and adjust it accordingly by the addition of additives, for example, until it reaches a desired range, preferably within the range of about 3 to about 8 pH.

Moisture control sensors may be placed strategically in one or more locations of the processing system to detect and control material levels within the processing devices, such as any conveyors and/or processing tanks. The particular moisture levels of interest may be selected and the process steps adjusted as necessary to ensure desired moisture content values are not exceeded. In one embodiment of the invention, the following moisture level targets are of interest: 1) raw litter material (the original biosolid waste material to be transformed) about <40%; 2) process material (the intermediate material formed during the course of the steps associated with transforming the raw litter material) about between 20% and 60%; and finish product (transformed biosolid material as useable product) about <15%. It may be undesirable to initiate the transformation process of the raw litter material when it has a moisture content greater than the value noted, as completing mixing of the material and additives may not be optimized.

As noted, the process includes the step of reducing the size of the particles embodying the transformed biosolid material. That may be achieved using a hammermill. Alternatively, particle reduction may be achieved with some other such grinding device. Further, particle sizing may be regulated to one or more selectable ranges through fractionation sizing of near-finished product granules. For example, an acceptable size range may be US MESH SIZE 2-30. Any particles falling outside of that range may be reintroduced to the process for reprocessing.

The steps of the regeneration process described herein, including the use of the one or more additives added to the raw biosolid material in selectable ways, result in the production of a finished biosolid material suitable for use in productive applications. The process provides for such finished product, which is substantially odorless, environmentally safe, and nutrient-rich. These and other features and advantages of the present invention will become apparent upon review of the accompanying drawings, the following detailed description, and the appended claims.

### BRIEF DESCRIPTION OF THE DRAWING

The FIGURE is a simplified block diagram of the process of the present invention, illustrating the transformation, regeneration, and utilization steps for treating raw organic biosolid waste material, constructed in accordance with the present invention, developed for processing raw poultry litter into a regenerated nutrient-rich organic biomeal for plant and/or animal feed, and block representations of the components of the system used to perform the steps.

### DETAILED DESCRIPTION OF THE PREFERRED EMBODIMENTS

As illustrated in the FIGURE, the present invention is a regeneration process for treating primarily biosolid organic animal waste, including, but not limited to, raw poultry litter, hog, beef and/or dairy waste. The process of the present invention treats organic waste material by integrating biological, chemical, and physical treatment reaction agents using either or both of two modes of operation (batch or continuous), under controlled conditions thereby creating a substantially odorless, nutrient-rich regenerated organic biomeal for plant and/or animal feed.

Resource Transformation and Regeneration Process

Raw Organic Biomass Storage

Raw organic biomass waste material is stored for a selectable period of time in an environmental and weatherproof facility as part of an initial conditioning step to substantially reduce migratory dust and foreign debris contamination. Preferably, the facility is constructed from a concrete material since the acids in the raw organic waste material can cause severe corrosion of metal and metal alloys. It is within the scope of the present invention that the raw storage facility be constructed from any non-leaching material including, but not limited to, concrete, plastic, etc. The initial conditioning step includes the step of removing trash from the raw organic waste material, such as by using a screening system, such as a multi-stage screening system. An example of a multi-stage screening system may be the type of device used to separate rocks and wood materials from dirt. However, the multi-stage screening system is not limited thereto.

The raw poultry litter organic biomass is received into the mixing facility at approximately 10% to 35% percent moisture content by weight and in various sizes, e.g., crumble, clumps, and debris, of the raw organic waste material. The uniformity of the raw organic waste material product size can be manipulated into a homogenous form, preferably by a hammermill. After the raw poultry litter organic biomass is substantially uniformly sized, it is held in storage ready for the primary mixer transforming process.

Primary Mixer

Upon completing the preliminary steps of uniformly sizing the raw material and confirming suitable moisture content, the primary mixing process includes the following steps: 1. Raw poultry litter organic biomass is placed in the primary mixer. The primary mixer may be a commercial-size batch mixer, such as a concrete mixer, for example. Alternatively, for a continuous process, the primary mixer may be one or more long mixing augers arranged to rotate at selectable revolutions per minute to establish adequate contact time for the components of the mixture to be formed therein. 2. The moisture content of the raw poultry litter organic biomass is determined. As indicated, the moisture content of the initial raw poultry litter organic biomass is preferably less than about 35% by weight before additives are added to the primary mixer. 3. The primary mixer is activated to begin tumbling of the raw material. 4. The raw material is continually mixed while one or more selectable additive reaction agents are added simultaneously or sequentially on a selectable schedule dependent upon the desired outcome of the finished product. Optional additives include oxidizers, enzymes, binding agents, bonemeal, feathermeal, ground charcoal, hydropolymers, molasses and pH control agents. 5. The moisture content of the mixture is measured and, if not within the range of about 20% to about 50% by weight, water is added until the desired moisture content is reached. 6. The mixture is then processed with a pin agglomerator to the desired particle size. 7. The mixture is then dried to a moisture content of about less than 15% by weight. The process time may range from about ten minutes to about 60 minutes, but is not limited thereto. The process time is selectable and dependent upon the particular raw material, the moisture content, the additives to be added to the mixer, and the required drying time.

During the primary mixing step, oxidation of the raw material occurs by adding one or more oxidizing agents in liquid or solid form at selectable level with a selectable mixing time, preferably about two (2) minutes in length for each additive, to ensure oxidation of the raw material. The oxidizing agent may be a biological or chemical oxidizer and peroxide is the preferred oxidizer. The combination of the blended organic biosolid material and the oxidizer(s) creates an oxidized regenerated organic biosolid material. At such time, a chemical reaction occurs, e.g., oxidation occurs in the mixed organic biosolid material, and the temperature of the oxidized organic biosolid material rises from the ambient temperature to approximately 95° F. Moisture content of the oxidized organic waste product is important at this stage of the process because of the critical mass of oxidizing agents to be added. Water may be added to bring the moisture level of the mixture to about 30% to about 40% by weight. One or more moisture sensors may be installed in or near the mixer to detect material moisture content. The moisture sensor may be an infrared sensor but is not limited thereto. Alternatively, samples of the mixed material may be extracted and tested for moisture content. A moisture feedback controller may be added to the system to regulate water addition based on moisture content information. That is, the controller may observe moisture content and increase or decrease water flow into the primary mixer. The regenerating oxidizing reactions and temperature rise occurring after the addition of the oxidizing agent(s), typically about three (3) minutes after addition. During this period, the oxidizing organic biosolid material must be mixed thoroughly to ensure proper mixing and complete oxidation of the raw material.

When an enzyme agent, such as Progest, is added to the mixture, it is necessary to allow the transformation of the raw material to occur for a specified period of time, generally by allowing the mixing to continue for no more than about ten (10) minutes. After about that period of time of the enzyme mixing with the raw material, a chelating agent, such as a chelated copper acid available under the product name pH 304-29 available from Challenge, Inc. of Jupiter, Fla. The chelating agent should be added in low doses to bring the pH of the mixture to a value in the range of from about 3.0 to about 8.0 pH. A Yucca plant extract and/or an activated charcoal may also be added to the regenerated organic biosolid material as a binding ammonia and odor control agent. Lastly, a binding agent such as molasses and/or lignin is incorporated to aid in the agglomeration process. Total time of primary mixing may range from about ten minutes to about 60 minutes.

Surge Mixer

Upon completion of mixing and additive addition, the primary mixed organic biosolid material may be held in storage with a secondary surge mixing device and maintained in motion by periodic, sporadic or continuous mixing. The surge mixer allows oxygen to be continuously incorporated into the primary mixed regenerated organic biosolid material prior to introduction into the agglomeration apparatus. Further additives such as potassium-enhancing compounds, phosphate-enhancing compounds, or both, may be added to the primary mixed organic biosolid material in the surge mixer or, optionally, in the primary mixer.

Pin Agglomerator

The next step of the process involves introducing the treated organic biosolid material into a pin agglomerator to create a nutrient-rich, organic biomeal product sized to be suitable for use with plants and animals. The pin agglomerator is used to agglomerate or increase the size of the particles into spherical shapes. The pin agglomerator is preferably used to agglomerate or pelletize the product to create product ranging in size from about 2 to about 30 US MESH SIZE. This fractionated sizing ensures that the resultant dried organic biomeal product is free flowing and, when using a dust control agent is used, virtually dust free. It can then be bagged in bulk. Any finished product falling outside of the noted size range may be reintroduced to the process, such as at the grinding or screening stage, for purposes of being re-introduced to the pin agglomerator.

Dryer/Cooler

The mixed organic biosolid material is then dried. The drying may be accomplished by transferring it to one or more thermal dryers typically of the drum/rotary or conveyor type dryers. Care must be used on the temperature of the dryers, so as not to scorch the product and thereby deplete nitrogen content. Nitrogen depletion starts at about 210° F. It is desirable to maintain nitrogen in the mixture as nitrogen is a desired element in the finished product However, it is also desirable to have the primarily mixed organic biosolid material to reach at least 200° F. and be held at that temperature for at least about five (5) minutes to ensure proper sterilization and killing of pathogenic organisms and any weed seeds that may exist in the biosolid material. One or more nitrogen sensors may be installed in or near the surge mixer to detect material nitrogen content. The nitrogen sensor may be an infrared sensor but is not limited thereto. A nitrogen feedback controller may be added to the system to regulate the introduction of nitrogen enriching additives including, for example feathermeal. That is, the controller may observe nitrogen level and increase or decrease feathermeal flow into the surge mixer. The regenerated organic biosolid material is preferably dried to a moisture content of about less than 15% by weight. Moisture sensors may be installed in the dryer to detect material moisture content. Alternatively, samples of the dried material may be extracted and tested for moisture content. Cooling may be achieved by simply letting the dried material continue to tumble in the dryer, but without adding heat. Ambient air is sufficient to ensure proper cooling. It is to be noted that the step of introducing the material to agglomeration/pelletization may optionally be performed after drying rather than prior to drying. In some instances, agglomeration/pelletization may be performed before and after drying as desired.

Storage

Any type of bulk storage bins can be used in the storage of the final organic biosolid product. If the final organic biosolid product is bagged, it can be stored by any warehouse means.

Resource Utilization

Bulk Loading

After storage of the regenerated organic biosolid, it may be bulk loaded onto trucks or the like for shipment to a desired end use, i.e., plant and/or animal feed.

Blend Mixer

To achieve the desired nutrient-rich blend, value added ingredients can be added to the regenerated poultry litter organic biomeal product and mixed in a blend mixer after formation of the regenerated product. For instance, bonemeal, feathermeal, ground charcoal, hydro-polymers, pH control agents, binding agents, etc., can be added in the desired amounts and quantities to produce a prescription delivered organic biomeal product. One or more inoculants including, but not limited to, actinomycetes and/or mychoriza may also be added at this stage of the process. It is to be noted that any one or more of these additives may be added to the mixture prior to the drying process.

Packaging

From the blend mixer, the mixed regenerated organic biosolid product can be packaged in various sized bags or containers for subsequent warehouse storage.

Warehouse

The packaged, mixed and regenerated organic biosolid product can then be stored in a warehouse until shipment to a desired end user.

Advantages of Using the Regenerated Biosolid Product

The regeneration process of the present invention converts raw poultry litter and other organic biosolid waste material into a beneficial organic biosolid product, such as a biomeal product. The regeneration process integrates biological, chemical, and physical treatment agents under controlled conditions creating an organic biomeal that is substantially odorless, environmentally safe, slow-release organic nutrient-rich product for plants and/or animals. The resulting benefits of the organic biosolids regeneration process of the present invention and the regenerated organic biomeal products are as follows.

Poultry Farmers

The product provides excellent adaptive management options for waste/resource recovery and utilization of poultry litter into natural organic products. It provides for implementation of nutrient management planning, not previously possible, for crop production and environmental resource protection. It provides for elimination of the long term negative environmental impact and effects of disposing of raw poultry litter by spreading it untreated on limited acreages of land resources.

Poultry Producers and Processors

The product provides for development and implementation of watershed management practices that will protect and improve the quality of surface and ground water resources. It provides for development and integration of ecosystem-based management with public relations programs to enhance the quality and health of the environment and its natural resources: soil, air, and water.

Urban and Rural Community Populations

The product provides for regeneration of poultry waste into a unique natural organic fertilizer for use on lawn, turf, and horticultural/ornamental house plants. It provides for the enhancement of air and water quality and environmental health. It provides for an acceptable level of healthy poultry production that sustains the economic base and employment opportunities for the urban and rural community populations.

Poultry Organic Fertilizer Processors and Producers

The product provides for regenerating and transforming smelly raw organic poultry litter into a pathogen-free, slow nutrient-release, organic fertilizer product. It provides for the production and marketing of natural organic fertilizers containing no synthetic chemicals, harmful pathogens or toxic substances. It provides for conservation of natural resources with redistribution and utilization of a previously raw organic waste, as an environmentally safe organic fertilizer product. It provides for complete resource recovery of raw poultry waste in a nutrient rich natural organic fertilizer for use in nursery, forestry, horticultural and agronomic plant production systems. It provides employment opportunities and enhances the sustainable economic base of the agricultural and urban communities. It provides an organic slow-release fertilizer that improves soil quality, tilth, and does not run-off or leach into water resources. It provides a value added organic fertilizer product that increases biodiversity in the soil ecosystem with increased population of soil microbes, earthworms, and natural biocontrol agents that enhance plant root growth and health, while reducing plant diseases and other pest problems.

The foregoing exemplary descriptions and the illustrative preferred embodiments of the present invention have been explained in the drawing and described in detail, with varying modifications and alternative embodiments being taught. For example, steps shown to occur in the surge mixer may occur in the primary mixer. While the invention has been so shown, described and illustrated, it should be understood by those skilled in the art that equivalent changes in form and detail may be made therein without departing from the true spirit and scope of the invention, and that the scope of the present invention is to be limited only by the following claims, construed in accordance with the patent law, including the doctrine of equivalents.

What is claimed is:

1. A resource regeneration process for creating an organic biosolid product from raw biosolid waste material, the process comprising the steps of:
a. initially conditioning the raw organic biosolid waste material to a substantially uniform size and moisture content;
b. adding the raw organic biosolid waste material to a mixer;
c. adding an oxidizing agent to the raw organic biosolid waste material in the mixer;
d. mixing the raw organic biosolid waste material and the oxidizing agent in the mixer to form a mixture;
e. measuring moisture content of the mixture and adding water to the mixer as necessary to provide the mixture with a moisture content of about 20% to about 50% by weight; and
f. mixing the mixture for about ten minutes to about sixty minutes of total mixing time in the mixer to form the organic biosolid product.

2. The process of claim 1 further comprising the step of drying the organic biosolid product to a selectable moisture content of less than about 15% by weight.

3. The process of claim 2 wherein any additive is added to the raw organic biosolid waste material or the organic biosolid product prior to the step of drying the organic biosolid product.

4. The process of claim 2 further comprising the step of pelletizing the organic biosolid product either before or after the step of drying.

5. The process of claim 4 wherein the organic biosolid product is pelletized to a size in the range of 2-30 US Mesh Size.

6. The process of claim 4 wherein the organic biosolid product is pelletized using a pin agglomerator, pellet mill or some other agglomerating device

7. The process of claim 1 further comprising the step of adding the enzyme Progest to the mixer.

8. The process of claim 1 further comprising the step of applying one or more moisture sensors to the mixer to detect moisture content of the mixture.

9. The process of claim 8 further comprising the step of adding a moisture feedback controller to regulate water addition based on moisture content information.

10. The process of claim 1 further comprising the step of applying one or more nitrogen sensors to the mixer to detect nitrogen content of the mixture.

11. The process of claim 10 further comprising the step of adding feathermeal or other natural nitrogen compound to the mixture to adjust nitrogen content.

12. The process of claim 11 further comprising the step of adding a feedback controller to regulate feathermeal addition based on nitrogen content information.

13. The process of claim 1 wherein the mixer is a mixing conveyor controllable to select rotational rate to achieve a specified mixing contact time.

14. The process of claim 1 wherein the step of initially conditioning includes the step of removing trash from the raw organic biosolid waste material before adding it to the mixer.

15. The process of claim 14 wherein the trash is removed using a single or multi-stage screening system.

16. The process of claim 1 wherein the oxidizing agent is peroxide.

17. The process of claim 1 further comprising the step of adding an enzyme to the mixture.

18. The process of claim 17 wherein the enzyme is Progest.

19. The process of claim 1 further comprising the step of adding an inoculant to the organic biosolid product.

20. The process of claim 19 wherein the inoculant is actinomycetes and/or mychoriza.

21. The process of claim 1 further comprising the step of adding one or more phosphate-enhancing compounds to the organic biosolid product.

22. The process of claim 1 further comprising the step of adding one or more potassium-enhancing compounds to the organic biosolid product.

23. The process of claim 1 wherein one or more additives are added to the mixture to adjust the pH to fall within the range of 3.0 and 8.0.
